(19) United States
(12) Patent Application Publication
(10) Pub. No.: US 2011/0131219 A1
(43) Pub. Date: Jun. 2, 2011

(54) SYSTEM AND METHOD FOR MANAGING MULTIPLE EXTERNAL IDENTITIES OF USERS WITH LOCAL OR NETWORK BASED ADDRESS BOOK

(75) Inventors: Gaelle MARTIN-COCHER, Toronto (CA); Michael SHENFIELD, Richmond Hill (CA); Suresh CHITTURI, Plano, TX (US)

(73) Assignee: RESEARCH IN MOTION LIMITED, Waterloo (CA)

(21) Appl. No.: 13/015,808

(22) Filed: Jan. 28, 2011

Related U.S. Application Data
(62) Division of application No. 11/952,804, filed on Dec. 7, 2007.

(51) Int. Cl. G06F 17/30

(52) U.S. Cl. 707/754; 707/E17.005; 707/E17.059

(57) ABSTRACT

A method and system for managing multiple external identities of users with a local or network based address book having the steps of: creating a set of address book field and value information, the set of address book field and value information being one or more external identities; and forwarding the one or more external identities to a receiving party.

### CROSS-REFERENCE TO RELATED APPLICATIONS

This is a divisional application of U.S. patent application Ser. No. 11/952,804 filed Dec. 7, 2007.

### FIELD OF THE DISCLOSURE

The present disclosure relates to address books, and in particular the managing of contact information in a local and a network address book.

### BACKGROUND

An address book is a book or database used for storing entities called contacts. Each contact entry usually consists of a few standard fields, such as: the first name, the last name, company name, address, telephone number, email address, fax number, cell number, instant messaging contact information, among others.

The information in an address book is usually input or updated manually or can be updated or input using various formats, such as: a lightweight directory access protocol data interchange format (LDIF) or a Versitcard (vCard), among others.

### BRIEF DESCRIPTION OF THE DRAWINGS

The present disclosure will be better understood with reference to the drawings in which:

FIG. 1 is an exemplary user interface for a contact with a work external identity;

FIG. 2 is an exemplary user interface for a contact with a home external identity;

FIG. 3 is an exemplary user interface for a contact with a travel external identity;

FIG. 4 is an exemplary user interface for assigning transition information for different external identities;

FIG. 5A is an exemplary diagram of an address book showing the user interface when scrolling over a particular user;

FIG. 5B is an exemplary diagram of an address book showing the user interface when clicking on a particular user;

FIG. 6 is an exemplary diagram of an address book showing integration of presence information;

FIG. 7 is an exemplary diagram of an address book showing integration with work status information;

FIG. 8 is an exemplary diagram of an address book showing integration of a corporate PBX;

FIG. 9 is an exemplary diagram of an address book showing integration with GPS information;

FIG. 10 is an exemplary user interface showing a contact having GPS information.

FIG. 11 is an exemplary diagram of an address book showing integration with a social networking server;

FIG. 12 is an exemplary diagram of an address book showing change information in a different font;

FIG. 13 is a block diagram showing the application of masks and contexts to contact data;

FIG. 14 is a block diagram of an exemplary mobile system having a converged address book server;

FIG. 15 is a block diagram of a hierarchical structure for relating external identities, nodes and values; and

FIG. 16 is a flow diagram of an exemplary method according to the present disclosure.

### DETAILED DESCRIPTION

The present disclosure provides for a system and method for defining multiple external identities of the user for the contacts in an address book. A user can create various address subsets such as: an address subset for personal external identity, an address subset for a professional/work external identity, and a subset for a traveling external identity, among others. The subset of fields and/or values of fields exposed to different contacts can be different for each. For example, a user that is to receive a work address subset could receive contact information of a work email address and an instant messaging address. Conversely, a contact that is to receive a personal address subset could receive a home phone number, an email address that contains a different email address than the work email address, a cell phone number, or other information.

A user can specify multiple external identities, which are various subsets of his or her full contact information set exposed to other users. The external identities are either statically predefined by the user or can be created and modified based on user specified rules upon the first or every request from the contact information requestor and can contain/link to either static or dynamic information. For example, an external identity containing only static information could be provided depending on the name or category of the contact accessing address information. The category can be broken up, for example, to include co-worker's, friends, family, sailing club buddies, among others.

An example of dynamic information contained in an external identity is when this information is established dynamically based on the rules specified by the user and associated with his or her dynamic status. Such dynamic status could include presence, location, time of the day, time zone, or network state, among others. Alternatively, the dynamic information in the external identity could be established based on the external identity of the contact information requestor.

The rules established by the user for building dynamic subset of his or her external identity may operate on static and/or dynamic fields of the receiving party external identity. For example, if an address book is configured to interact with a social networking site, the information about the recipient could be used to build the dynamic subset of user's external identity, for instance if the recipient is defined in this social networking site as user's “friend”, the recipient gets a broader set of user's contact information as opposed to the general public. In another example, the user's external identity could depend on whether the receiving party is in the same time zone as the user, whether he or she is currently driving or not, etc.

The address book, in various embodiments, could be tied to other information servers or services. For example, the address book could have knowledge of a contact's presence through a presence server, knowledge of a contact's telephone activities by being integrated with a corporate private branch exchange (PBX), knowledge of a contact's information through a location service or global positioning service (GPS), knowledge of a contact's schedule by being integrated with a contact's calendar, or knowledge of a contact's personal information through integration with a social networking site, among others. The knowledge of the auxiliary information could be used to update or arrange a contact's information to make the information more relevant.

Further, an address book on a mobile device could be synchronized with a network based address book to accomplish the above.

The present disclosure therefore provides a method for managing multiple external identities of users with a local or network based address book comprising the steps of: creating a set of address book field and value information, said set of address book field and value information being one or more external identities; and forwarding the one or more external identities to a receiving party.

The present disclosure further provides an address book for managing multiple external identities of users, the address book being local or network based, comprising: a processing module adapted to create a set of address book field and value information, said set of address book field and value information being one or more external identities; and a communications module adapted to forward the one or more external identities to a receiving party.

In the address book of a user, the user can save his or her information in various fields. For example, this can include, but are not limited to: the name, email address, a second email address, among others. The address book is either a network based address book (also referred to as a converged address book) or the address book can be a local address book present on a user's device that is synchronized with a network based address book.

The address book provides notification of the user's contact information updated to each receiving party linked to the user. Another means to update a user's address book would be to directly provide updates, for instance in the case when user subscribes to contact changes. Contacts in the address book can be classified under different categories. For example, this includes, but is not limited to, friends, co-workers, family, among others. Notification can be subject to the rules applicable to the category. The address book can further contain additional information, such as a user's presence information (available, busy, offline, among others) and communications presences (short message service (SMS), email, instant messaging (IM), among others).

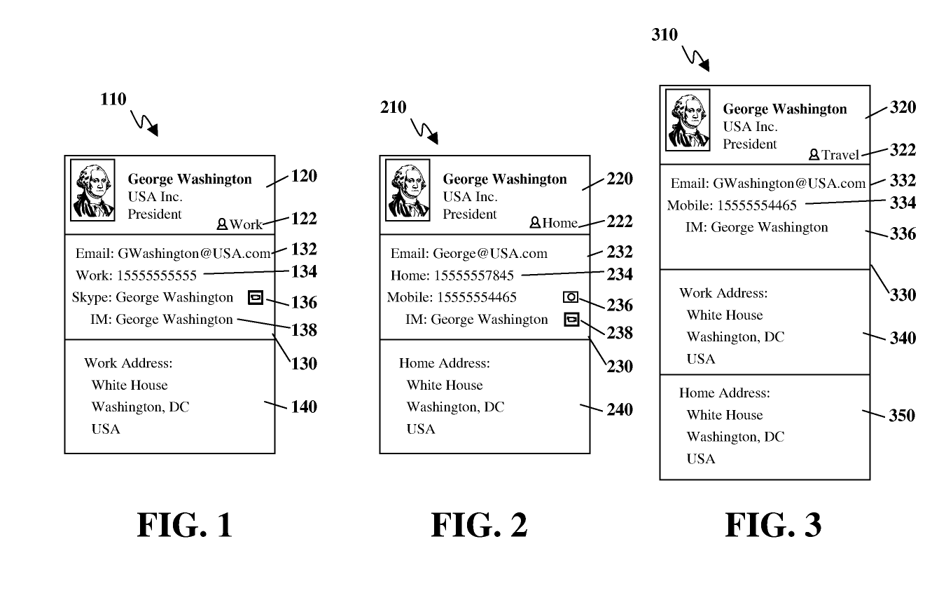

Reference is now made to FIG. 1. FIG. 1 shows a user's contact information when the person accessing the contact information has been identified as a “work” contact. In FIG. 1, address subset 110 can include an external identity portion 120 that includes, for example, a user's name, company, and title among others. A field 122 could also indicate the type of external identity that is being shown.

In the example of FIG. 1, the address subset 110 includes various contact information 130, including an email address 132, a work phone number 134, a Skype™ address 136, and an IM address 138.

The address subset 110 further includes a work address 140.

Referring to FIG. 2, a home address subset 210 is presented to contacts that have been identified to receive the “home” address subset.

Address subset 210 includes identification information 220 and information about the external identity type 222.

Further, a contact information area 230 is provided. In contact information area 230, an email address 232, a home phone number 234, a mobile phone number 236, and an IM address 238 are provided.

A home address field 240 is also provided to contacts receiving the “home” address subset.

Referring to FIG. 3, FIG. 3 shows an address subset 310 that is designated as a “travel” address subset. Under the travel address subset 310, identification field 320 is provided including the name, company and position title. An external identity type field 322 is also presented in some embodiments.

A contact information area 330 is provided in address subset 310. Contact information 330 includes an email address 332, a mobile phone number 334, and an instant messaging address 336.

Further, address subset 310 includes a work address 340 and a home address 350.

When comparing FIGS. 1, 2 and 3, it will be apparent to those skilled in the art that both the fields and the information within the fields change based on the type of address subset. Specifically, in FIG. 1, the work address subset 110 includes a work email address that is different from the home email address 232 in address subset 210 of FIG. 2.

Also, the instant messaging contact information 138 from FIG. 1 is different from that of 336 of FIG. 3. Thus, both the fields that are presented to a user and the information within these fields can vary based on the address subset.

The above references to FIGS. 1, 2 and 3 therefore provide for address subsets to be set based on the static information of the category of receiving party.

The above could be, for example, implemented using an extension to the vCard. A standard vCard example includes:

BEGIN:VCARD
VERSION:3.0
FN:Joe Smith
TEL;WORK: +1-111-111-1111
TEL;HOME: +1-222-222-2222
TEL;CELL:+1-333-333-3333
URL:http://www.example.org/joesmith
EMAIL;INTERNET:joe.smith@example.org
END:VCARD

As will be appreciated by those skilled in the art, an “hCard” is an hypertext markup language (HTML) vCard and is a microformat for publishing contact information in Atom, RSS, or arbitrary XML. Mapping of Standard vCard to hCard example:

```
<div id=”hcard-Joe-Smith” class=vcard”>
    <a class=“url fn” href=“http://www.example.org/
    joesmith”>Joe Smith</a>
    <a class=“email”
href=“mailto:joe.smith@example.org”>joe.smith@example.org</a>
    <div class=“tel”>
        <span class=”type”> WORK</span> +1-111-111-1111
    </div>
    <div class=“tel”>
        <span class=”type”> HOME</span> +1-222-222-2222
    </div>
    <div class=“tel”>
        <span class=”type”> CELL</span> +1-333-333-3333
    </div>
</div>
```

The above could be extended by adding two fields to a vCard format. These fields include:
1) VIEW EXTERNAL IDENTITY—A view external identity type will indicate the view external identity this vCard will represent. Therefore, for multiple external identity of the same user multiple vCard's need to be created with a different matching view external identity value and associated information;
2) VIEW SKIN URL—A view skin uniform resource locator (URL) represents the URL to the “skin” of the UI that should be applied to the current external identity view.

With the extensions to the above vCard format, examples with multiple views could include:

External Identity/View 1 (Personal)

BEGIN:VCARD
VERSION:3.0
FN:Joe Smith
VIEW EXTERNAL IDENTITY: Personal
VIEW SKIN URL:http://www.example.org/joesmith/skins/personal
TEL;HOME: +1-222-222-2222
TEL;CELL:+1-333-333-3333
URL: http://www.example.org/joesmith
EMAIL;INTERNET:joe.smith@example.org
END:VCARD

External Identity/View 2 (Professional)

BEGIN:VCARD
VERSION:3.0
FN:Joe Smith
VIEW EXTERNAL IDENTITY: Professional
VIEW SKIN URL:http://www.example.org/joesmith/skins/professional
TEL;WORK: +1-111-111-1111
TEL;CELL:+1-333-333-3333
URL: http://www.example.org/joesmith
EMAIL;INTERNET:joe.smith@example.org
END:VCARD

As with the above, the vCard can be mapped to hCard:

External Identity/View 1 (Personal)

```
<div id=”hcard-Joe-Smith” class=vcard”>
    <a class=“url fn” href=“http://www.example.org/
    joesmith”>Joe Smith</a>
    <a class=“email”
href=“mailto:joe.smith@example.org”>joe.smith@example.org</a>
    <div class=“tel”>
        <span class=”type”> HOME</span> +1-222-222-2222
    </div>
    <div class=“tel”>
        <span class=”type”> CELL</span> +1-333-333-3333
    </div>
    <div class=”view external identity”>Personal</div>
    <a class=”view skin URL” href=” http://www.example.org/
joesmith/skins/personal”>View Skin URL</a>
</div>
```

External Identity/View 2 (Professional)

```
<div id=”hcard-Joe-Smith” class=vcard”>
    <a class=“url fn” href=“http://www.example.org/
    joesmith”>Joe Smith</a>
    <a class=“email”
href=“mailto:joe.smith@example.org”>joe.smith@example.org</a>
    <div class=“tel”>
        <span class=”type”> WORK</span> +1-111-111-1111
    </div>
    <div class=“tel”>
        <span class=”type”> CELL</span> +1-333-333-3333
    </div>
    <div class=”view external identity”>Professional</div>
    <a class=”view skin URL” href=”
http://www.example.org/joesmith/skins/
professional” >View Skin URL</a>
</div>
```

As will be appreciated by those skilled in the art, it is possible that the user may offer more than one of his or her external identities to a single contact. In this case, the presentation methods for the different external identities may include the ability to view the different external identities or different field of the various external identities by, for example, scrolling, tabs in the contact display, menu items, links, among others. The above is not meant to be limiting and various viewing options are available as would be appreciated by those skilled in the art.

Views may be customized with specific skins associated to each external identity for better visualization. The skins can include information such as background images, color of the text, fonts used for the address book, icons or other visual information.

Address subsets may be dynamic. Thus, an address subset could be based on a current status, such as a presence, location, among others of the viewer and of the person whose contact information is shown. The address subset may also be pseudo-static and thus, dependent on certain rules defined by the content information owner (e.g.: includes phone and cell phone during the day, but only cell phone in the evening). These rules are applied to build an external identity when someone requests contact information for the first time or for subsequent updates. Rules may also include validation on whether the requesting contact belongs to certain groups, clubs, geographical locations, among others.

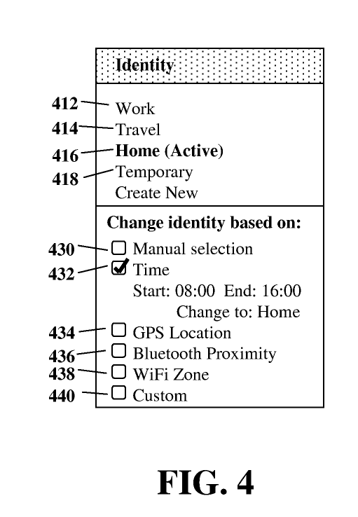

References are now made to FIG. 4.

Some external identity selections settings can be associated to each external identity of a contact in an address book. For example, a “work address subset” can be shown as active or default from 9 a.m. to 6 p.m. A driving address subset could be shown between 8 a.m. and 9 p.m. and 6 p.m. and 7 p.m. A no phone calls address subset can be shown at night. A home address subset could be shown at other times. FIG. 4 illustrates a menu for setting and creating such defaults.

In the example of FIG. 4, four address subsets are provided. The example FIG. 4 includes a work subset 412, a travel subset 414, a home subset 416, and a temporary subset 418.

The example of FIG. 4 further includes settings to change between the address subsets. Thus, in the example of FIG. 4, the address subset could be selected based on manual selection 430. The address subset could also be changed based on time field 432.

The address subset could also be changed based on a location field which could be use by any location type methods such as GPS, AGPS, cell ID, SSID, WLAN, etc. 434.

The address subset could also be changed based on a Bluetooth proximity field 436.

The address subset could also be changed based on an alternative radio access field (e.g.: WIFI zone) 438.

The address subset could also be changed based on a custom field 440.

In particular, time field 432 could indicate that between certain times, a certain address subset should be active, and could also indicate which external identity to switch to after the time expires. In the example of FIG. 4, time field 432 includes a start time and an end time and indicates that it should change to a home address subset when the end of time has expired.

The location field (e.g. GPS) 434 could, for example, be used to indicate that if the user within a certain geographic area, a work address subset could be activated. Alternatively, if the user is in a different location corresponding to the user's home, the home field could be activated. Alternatively, if the user is in a user that does not match work or home, a travel external identity could be utilized.

Bluetooth proximity field 436 could indicate that if the device is capable of communicating via Bluetooth, then a certain address subset should be switched to.

Similarly, if an alternative radio access field 438 which could be used for WiFi zone, Bluetooth, WiMax, LTE, etc, could indicate that if the device is capable of communicating over the alternative radio access methods, a certain address subset should be switched to.

A custom field 440 could be utilized to create rules, for example, if various fields present conflicting information about which address subset to switch to. This could be used to indicate which fields take precedence, among others. The custom field could also utilize other criteria than those indicated above.

Utilizing the example of FIG. 4, a receiving party wants contact information for a user. If the receiving party is designated as a work colleague, the user may have set the address book to only provide a work address subset to work colleagues. During the hours of 9 am to 6 pm, from the settings in FIG. 4 a complete address subset for work could be presented to the receiving party.

After 6 pm, a home address subset could be specified by the user. In this case, if the receiving party does not have rights to receive the home address subset, the work address subset may still be provided to the receiving party, but with less fields. For example, if the work address subset includes a work telephone number during business hours, this may be removed after business hours since the user cannot be reached at that number.

As what will be appreciated, when sharing a user's information, the settings would apply and the user information is displayed according to his or her contacts.

In a further embodiment, the user could provide communication preferences for each of the different address subsets. The preferred communications method could appear first or appear highlighted and alternative communications information could be available only when expanding the contact details in an address book.

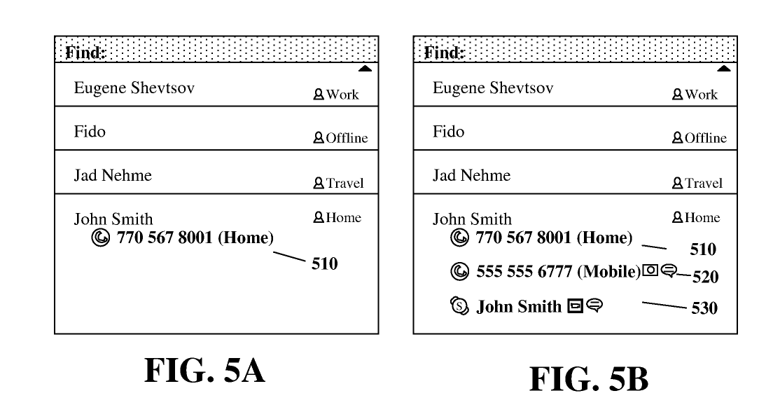

Reference is now made to FIG. 5A. In FIG. 5A, when a user scrolls over a name the preferred communications method is displayed. In the case of FIG. 5A, the home phone number 510 is the preferred communications method for this particular receiving party, and thus, the home phone number 510 is displayed. If the viewer then clicks on the contact, other information such as the cell phone number and a Phone over IP, e.g.: Skype™, identifier appear. This is illustrated in FIG. 5B, where mobile number 520 and Skype™ information 530 are displayed. The home phone number 510 remains for both the embodiments of FIG. 5A and FIG. 5B.

In a further embodiment, if the address book allows multiple variants for the same communication method, the information displayed for the contact external identity should be shown with the preferred variant for each communications method as the obvious choice. Thus, for example, if a contact has multiple emails addresses and it if is possible to send an email from the address book, the address book should show by default the preferred email address for the address subset of the contact offered to the address book owner. If this address subset contains other email address for the contact, these could be shown upon additional action such as expanding a drop down list, scrolling, menu selection, among others.

Further, if a communication application on the device allows communicating by selecting a contact from the address book, the user should only view the address subset, contact, and the default valid email address, instant messaging identifier, among others, according to the current contact external identity, which will by default be used by the communications application. For example, a receiving party wants to email John Smith. John Smith has multiple emails addresses, but one that is set for the default address for the current contact external identity. Thus, if the receiving party is utilizing an email application and selects John Smith, the email application should utilize the default email address when creating the email to be sent.

As will be appreciated by those skilled in the art, the above works both for both non-connected and non-shared address books, as well as the connected and network based address books described above.

As will be appreciated, if an address book is a network based address book, various other information may be available to the address book that can be integrated into the address book.

In a first embodiment, presence information could be available and integrated with the address book. This could significantly increase the value of contact information in the address book. Instant messaging status and presence information could appear in the contact field when relevant. Further, the available communications method could be reflected in the different address subsets.

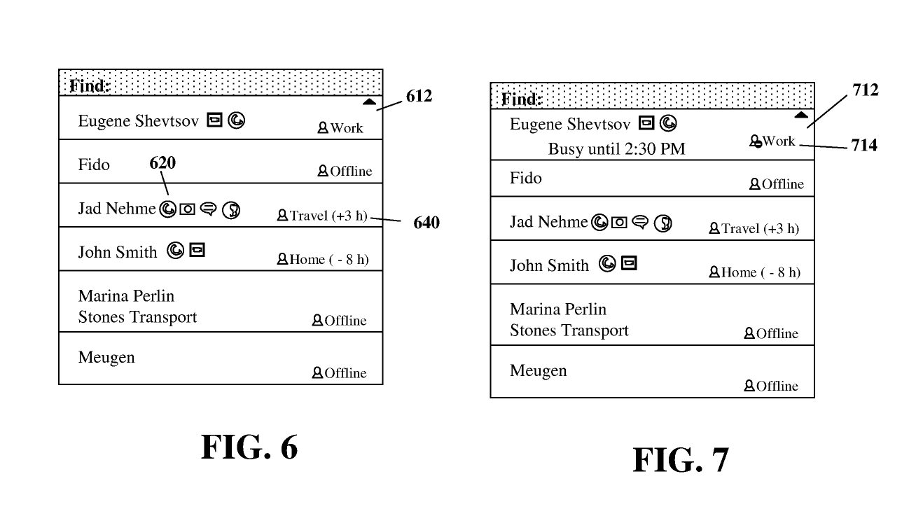

Reference is now made to FIG. 6.

FIG. 6 shows an address book in which contact information has presence information included therein. For example, in FIG. 6, the present “external identity” status is shown in field 612. Also, icons 620 are provided that could reflect the presence information for a user.

In other embodiments, a presence time stamp 640 could be provided to indicate easily to a user that the contact is in a time zone which is ahead or behind of the user's current time zone by a certain amount of time.

As will be appreciated by those skilled in the art, presence information usually requires frequent updates by communications between the device and the present platform. One way to save device resources and bandwidth would be to integrate into the address book the presence information of a contact, that is also a contact in an instant messaging application, the presence status of the contact in the instant messaging application.

In a further embodiment, the user's own presence status could be updated by signaling, as part of a message, the user's state. One example of signaling could be how long since the user's last interaction with the device. This status identifier could be posted to the presence server (e.g. via the host server (email, MMS, SMS servers) or an intermediate server (or gateway), which can pass the information to the presence server). In this case, a converged address book utilized presence information and the converged address book server in the network retrieves this information from the presence platform and the address book of each user can be updated with the presence states of the contacts.

An example of this is found in PCT publication WO 2005/017770, the contents of which are incorporated herein by reference. This document describes a system and method for integration between an address book and instant messaging application on a mobile device. This is for offering a consolidated view of a contact's address information and instant messaging handle (contact) and through an aggregated UI a user be made aware of a contacts individual or group IM presence status as well as initiating IM related operations such as initiating an individual or group IM conversation based on access to the address book and Instant messaging databases. Furthermore the document includes use of APIs for IM and Address book to allow for the aggregated data view to be presented both by the Address Book and IM UI. Additionally the API's can be used to add new entries, edit existing ones and also reflect IM contact presence information. The API for the aggregated data view provides an indirection repository based on VM object based storage for storing API entry points. The Address Book application incorporates a schema where metadata can identify the address book and instant messaging related fields for the Address Book UI. In the Address Book UI a buddy list can be displayed and IM actions such as starting an individual or group conversation can be performed. Within the UI as previously mentioned both individual and group presence availability is reflected. Furthermore contact name and IM handles are displayed side by side in the UI for improved association.

Additionally, in order to limit the communication between client and servers for presence status, if presence information is sent to the device and integrated into the address book to update contact information, the display of presence information in the user interface can be modified, over time or turned to inactive if the period between the two subsequent updates of presence information is over a predefined time threshold.

PCT publication WO 2005/060221, the contents of which are incorporated herein by reference relates to a set of rules to a contact profile (address book entry) on a mobile device where the rules indicate what method of communication (phone, email, text) the contact prefers to receive. When the mobile user sends a message to the contact the preferred method of communication is used based on the rules applied to the contact's profile.

PCT publication WO 2005/027383, the contents of which are incorporated herein by reference, relates to presence information, which is typically in the form of “available”, “away” and “disconnected”. In addition, the user can typically set their own state, to either one of the predefined ones, or a custom one like “at the gym”, but most users rarely configure a custom state. On a mobile device with telephone and organizer functionality, it is possible to automatically set and unset a few additional states, including “on the phone” when a phone call starts and ends, or “in a meeting”, if the Calendar has an appointment for the current time period. It's also possible to set additional states based on some applications or services being active or not, or based on inactivity timeouts. This reference shows how this rich presence information could be presented to the user, with icons and strings.

U.S. patent application Ser. No. 11/567,260, the contents of which are incorporated herein by reference, relates to a method and apparatus to maintain accurate presence information for a given mobile device without introducing substantial new traffic to the wireless network by deriving mobile device presence information by analyzing or monitoring the traffic going to and from the mobile device.

The address book could be also associated with a calendar for the user. If this is the case, the availability status can be updated based on calendar information. For example, if in the work external identity, when the user is in a meeting, the user can be shown as ‘busy’. If the receiving party is within the same corporate domain, additional information could also be displayed to the receiving party when viewing the contact information. Thus, for example, the contact can be shown as busy and in a meeting with John Smith until 11:30 a.m. Similarly, if the user is shown as out of the office, the address book user interface can reflect this and the preferred method of communication can be altered. For example, if the user is out of the office, the preferred method of communication can be shown as cell phone first and office phone number last.

Reference is now made FIG. 7. FIG. 7 shows an address book that utilizes calendar information to update the address book. For example, a receiving party looking at contact 712 sees that the contact 712 is in a meeting until 2:30 p.m. and an icon 714 indicates that communication is not possible with the user.

In a further embodiment, the address book can also be integrated with a corporate private branch exchange (PBX). In this case, the preferred contact method can reflect that the user is on a call and the message will be derived to a voice mail.

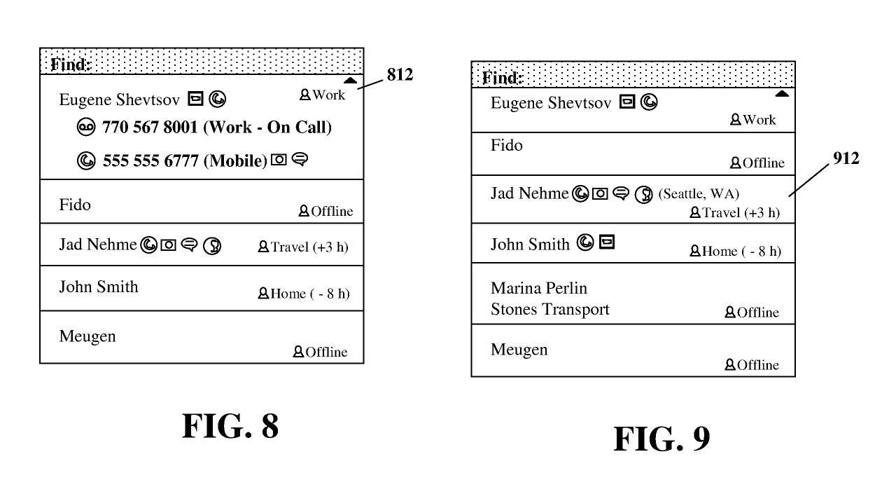

Reference is now made to FIG. 8. FIG. 8 shows an address book in which the address book integrated with a corporate PBX. In this case, the corporate PBX provides information that a contact 812 is currently on a call, which might provide a receiving party the ability to go directly to voice mail or to not attempt the call until contact 812 is off the phone.

As will be appreciated by those skilled in the art, when an address book is regularly synchronized or connected with a centralized address book, the detection of relevant user external identities can be updated on a more accurate basis.

For example, if user is roaming or traveling in a different time zone, the user's device could retrieve the local time and notify the central address book to switch the contact information for the user to a “travel address subset” for other users. This could be done manually or automatically on user settings. Further, the time zone offset could be made available as part of the traveling addresses subset for other users. Additionally the availability status of the user is switch to the relevant state.

As will be appreciated, if the address books are connected through a presence system, the above could also be achieved.

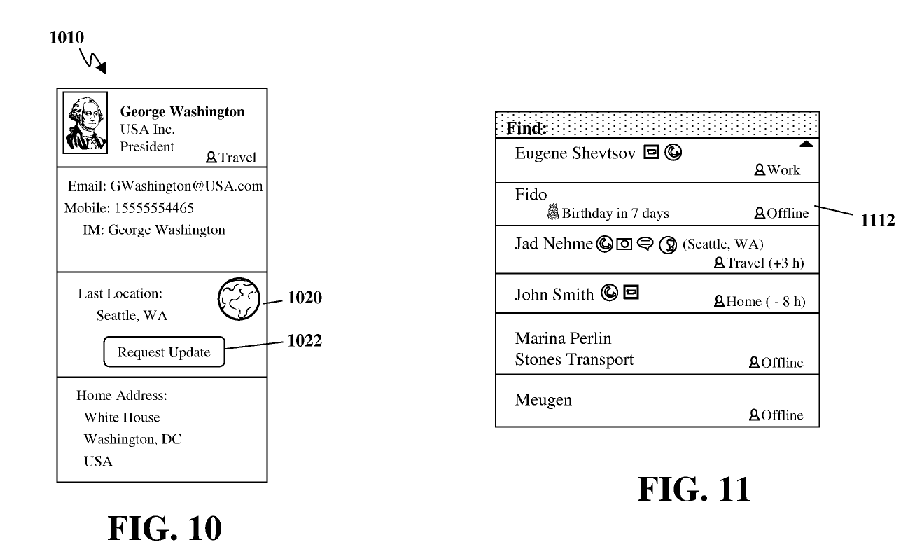

Further, if the device is location enabled for example GPS enabled or GPS assisted, the traveling address subset could be updated with the latest location of the user. As will be appreciated by those skilled in the art, when referring to GPS in the present disclosure, other location methods are equally applicable, including waypoints, CGI, service set identifier (SSID), among others. The user's GPS location could then be used to offer location-based services such as directions to or from another contact in the address book, local weather information for the contact, nearby points of interest, information, meeting or conference rooms in the vicinity, among others. This could, as will be appreciated, be displayed in the address book. Referring to FIG. 9, a contact 912 includes GPS enabled device information, such as where the user currently is. Referring to FIG. 10, if a viewer has clicked on the contact 912 from FIG. 9, the information for the user 1010 is presented and a last location area 1020 is provided indicating the last location of the user. Further, a request button update 1022 could be provided to the user to update the location of the user whose information is displayed. Alternatively, a periodic update could be performed by the device.

Further, other means to switch from one external identity to another would be apparent to those skilled with the art having regard to the above. Specifically, if a user switches the external identity manually, upon GPS location, upon time, upon Bluetooth or WIFI zone detection for known areas such as work or home, this could be reflected in the address book.

In a further embodiment, the address book could be connected to a social network system or application. Examples include Facebook™ or Plaxo™. In this regard, additional information such as personal events could be reflected for the address subset. For example, the address book could display the birthday or anniversary date for a personal external identity, personal URLs.

Reference is now made to FIG. 11.

FIG. 11 shows an address book in which a social network system has been integrated. In FIG. 11, contact 1112 is a personal contact, rather than a professional contact and in this case, contact 1112 includes information that their birthday is in 7 days.

As will be appreciated, the social networks could be used for other information, such as utilizing an avatar instead of a user's picture or utilizing an updated picture for the social network. Such information may not be initially part of the shared contact information and can be added or restored as part of the contact details. Additional information could also follow a different storage or sharing policy according to the user, contact or service provider or based on preference settings.

In a further embodiment, notification of changes from contact could be reflected in the address book utilizing various visual aspects such as different colors, different fonts, and different backgrounds, among others. Thus, if a user changes his or her telephone number, viewers of this contact could see the telephone in red until they selected the contact or interacted with that contact. The viewer may have the choice of accepting or refusing all or part of the changes. A user, in some embodiments, could automatically accept all or part of the changes for all contacts or all or part of the changes for certain category of contacts.

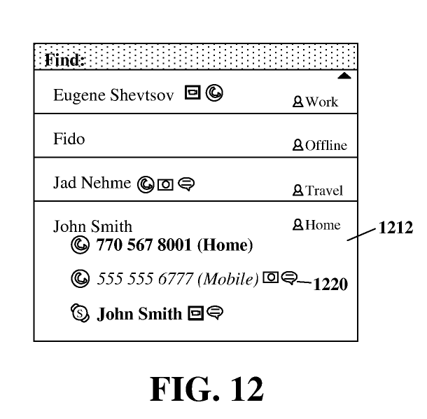

Referring to FIG. 12, FIG. 12 shows a contact 1212 in which a mobile phone number has changed. The contact 1212 shows mobile number 1220 as different font until it has been selected.

In a further embodiment, a free field could allow a user to advertise specific information by entering the information manually in the free field, entering a URL to an RSS field or other similar means that could allow a user's contacts to see an icon, information, advertisements, recommendation that would have been selected directly or indirectly by the user. The free field can be directed or used by a particular application, such as an advertisement solution, a specific category of social networking tool, a mood or smiley from an instant messaging application, among others.

FIGS. 4 to 12 therefore provide examples of where dynamic information can be used to make changes to an address subset.

In a further embodiment, if a receiving party is set to a particular external identity, his or her address book can be set to present him or her with a subset with his or her contacts that will be relevant to that particular external identity. For example, if the receiving party is in the “travel address subset” but is on holiday, the receiving party may choose to see only personal contacts in his or her address book and/or a subset of the professional contacts such as close team members. Additionally, the receiving party will be shown with his or her travel address subset, but be displayed as not available or with minimal information to non-personal contacts.

The above therefore provides for formatting and use of address subsets based on a receiving party's information.

The network or converged address book is defined as a centralized address book that contains users and contacts information on behalf of converged address book users (subscribers). The converged address book provides the methods to create the different external identities for the users.

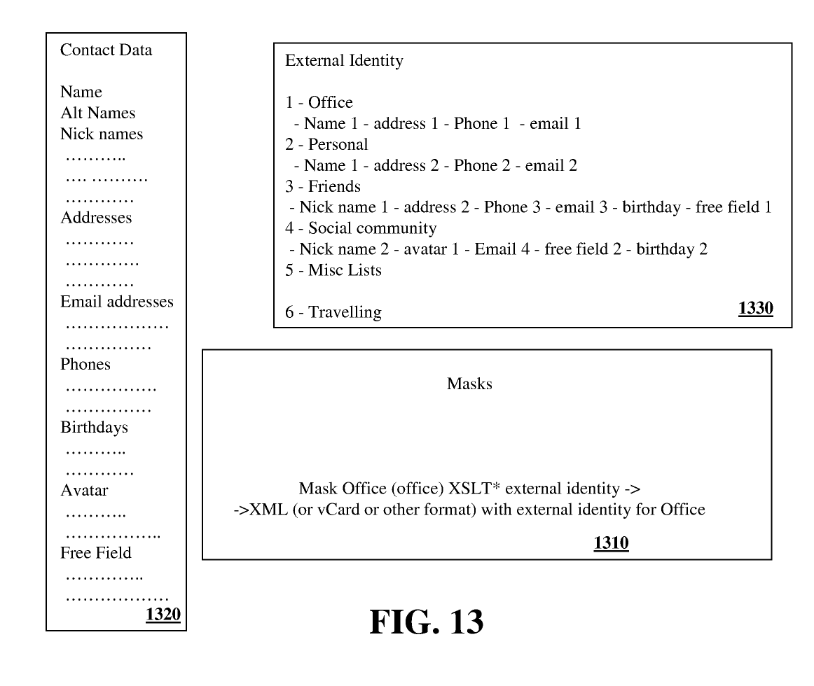

One particular method of a network/converged address book to define and create external identities on behalf of a user is shown with regard to FIG. 13. In FIG. 13 a mask 1310 could be applied to information related to a contact. A user would be given the capability to define, upload, and modify all his or her information 1320 and different external identities 1330. When sending his or her information to another user, or when another user retrieves the first user's information from the converged address book, a mask is applied to create the external identity that has to be exposed to the other user. The mask 1310 contains all necessary rules and information to create or publish the different external identities. The mask can reside within the device or in the network where the address book is stored. In the case of a local address book, the different identities and the mask can be created on the device before sending the contact information. For instance, this could be a new vCard format. In FIG. 13, contact information is stored in contact data 1320 and various external identities are defined by the users and shown as 1330.

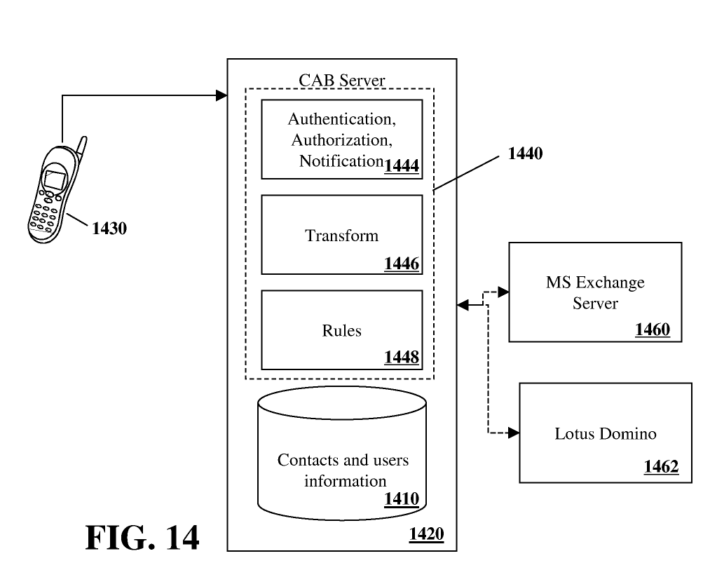

Reference is now made to FIG. 14.

In the case of a network address book, users can upload a full set of their contact information. The network address book will create a different mask in views of the user when his or her contact is required by others. Particularly, when another user is authenticated as a “professional contact” the mask “office” could be applied to the contact information before it is delivered.

In the case of FIG. 14, a converged or network address book stores contacts and users information for CAB users in a common database 1410 which is either located on a network/converged address book (CAB) server 1420 or accessed remotely by the server. A mobile device 1430 can either access contact information in CAB directly using one of the data access protocols or to have its local address book synchronized with the CAB server 1420 and with the CAB database 1410 utilizing XML vCard format or one of the data synchronization mechanisms; or other means that would be apparent to those skilled in the art. Mobile devices 1430 are well known in the art, and can include any wireless device, mobile data device, personal digital assistant, digital pager, laptop, or other data device.

When a mobile device 1430 contacts CAB server 1420, a processing module 1440 includes an authentication, authorization and notification module 1444, a transformation module 1446 and a rules module 1448. Authentication, authorization and notification module 1444 is utilized to authenticate the mobile device 1430 utilizing any technique known to those skilled in the art, authorize for access to contact data, and notify about the changes in the known external identities. Further, when the mobile device 1430 wants to retrieve contact information for a contact, the data is then transformed by module 1446 with respect to the rules applied by module 1448 to data that is stored in CAB database 1410. The transformations and rules may be applied prior to the data request from the mobile device 1430 and the requested external identities may already be stored and ready for retrieval in the CAB database 1410.

CAB information or information from a local address book can be stored on mobile device 1430 within an internal or external memory. Examples of such memory are known to those skilled in the art, and for external memory can include a (universal) subscriber identity module ((U)SIM), removable user identity module (RUIM), Compact Flash, MicroSD, memory sticks, among others. A mobile device can then write to the external or internal memory and read from it.

The exemplary steps of the above CAB server 1420 may include:
1—A user synchronizes his or her address book with a CAB server or makes a request to create the contact;
2—The CAB server, after all authorization and security steps have occurred, will search for the relevant data to see if the user is allowed to see the particular content;
3—The CAB server then applies rules according to preferences or policies of the requested contact on the contact information;
4—The CAB server applies a transformation defined in the mask, for example, an XSLT transformation to create an external identity by extracting, filtering, and updating the relevant information from the contact data; and
5—The CAB server transfers the subset of contact data to the requesting user.

As will be appreciated by those skilled in the art, the exemplary steps of CAB server 1420 identified above are not limiting, and other implementations would be evident to those skilled in the art.

In addition to the above, additional steps could adapt the data to the user devices capabilities. For instance the XSLT transformation could provide a vCard, extended vCard, hCard, or HTML document to deliver the contact external identities to a particular device.

Additionally, to simplify the mask creation, a hierarchical graph structure (e.g. nested XML document) could be used, where a node works as a category definition. Any fields can be freely linked to any external identity or to any category. Some categories may be present in a CAB but not link to any external identity. (e.g.: for a period of time, based on user selection etc) The address book display of fields is based on a selected external identity but not on standalone categories. For example, a work category means displaying work information first, along with a preferred communications channel. Other information could be available or not depending on permissions, and utilize different levels of access (e.g. see all in a menu, or scroll further down etc).

Additionally the rules and policy of a given mask could facilitate the update of an external identity based on dynamic modification of information that is part of a group, category or external identity. For instance the User Interface could display a small difference of the social community icon if information from the social community node has been updated. For resource reasons, such updating in the UI could be provided based only on a user subscription or on specific devices condition (WiFi, LAN connections, plugged devices etc).

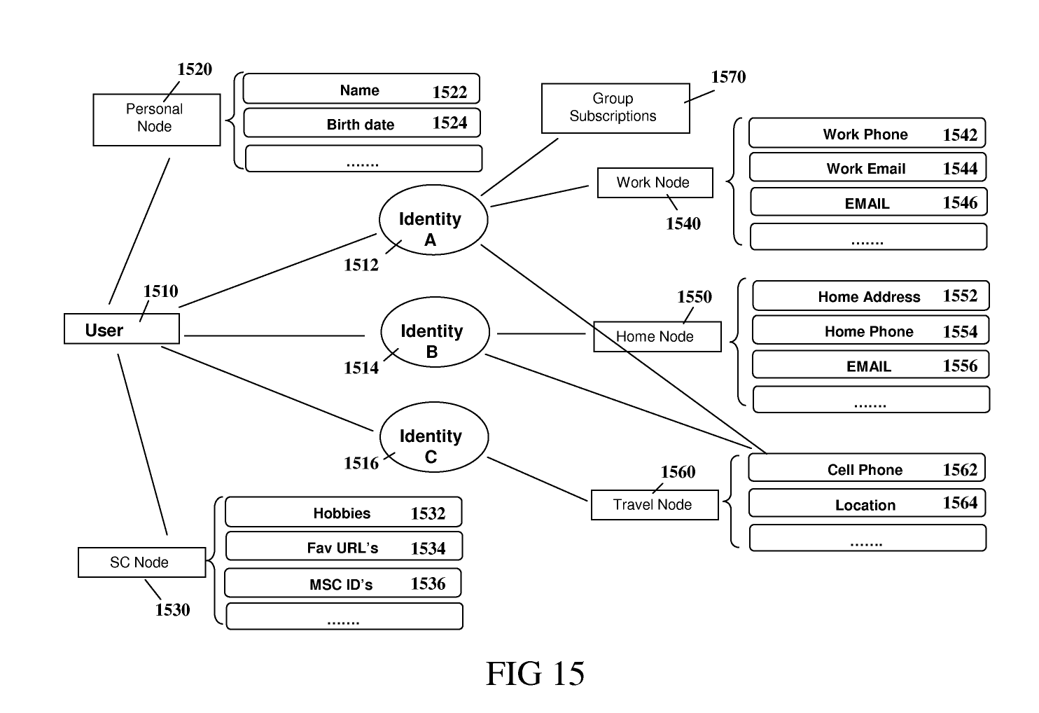

Reference is now made to FIG. 15. FIG. 15 shows a user 1510 that has 3 external identities defined. Specifically, these are shown as identity A 1512, identity B 1514, and identity C 1516.

A user has a link to a personal node 1520, which defines personal information such as name 1522, birthdate 1524, among others.

A user further has a link to a Social Community (SC) node 1530. SC node 1530 includes information such as hobbies 1532, favorite URLs 1534, SC IDs 1536, among others.

Identity A 1512 is associated with a work node 1540, which includes various information such as a work phone 1542, a work email 1544, and an alternate email 1546, among others.

Identity B 1514 is associated with a home node 1550. Home node 1550 includes a home address 1552, a home phone 1554, and an email address 1556, among others.

Identity C 1516 is associated with a travel node 1560. Travel node 1560 includes information such cell phone number 1562, a location 1564, among others.

Identity A 1512 and identity B 1514 also have a link to a cell phone number 1562, thereby providing the ability to display this number associated with this external identity.

Identity A 1512 also includes information about group subscriptions 1570. The above therefore provides for the linking of fields to any external identity or any category based on a hierarchical graphical structure.

Further, CAB rules and transformation components could be abstraction layer above, for example, a Lotus notes or a Microsoft exchange server where could be stored contacts and users information. This is shown by Microsoft exchange server 1460 and Lotus notes server 1462 in FIG. 14.

Additionally, the CAB mask can be based on PEEM policies and methods. The OMA PEEM policies would apply as a set of rules in module 1448 of FIG. 14. OMA PEEM PEL specification defines the language in which policies can be expressed. The PEL specification includes the definition of language constructs, and may define multiple language options, for the convenience of resolving particular issues. In order to use PEEL for the common address book the conditions for the address book needs to be define as describe above. The PEEL policy could then apply to the address book specific conditions. Additionally an extension of the common PEEL policy may be needed.

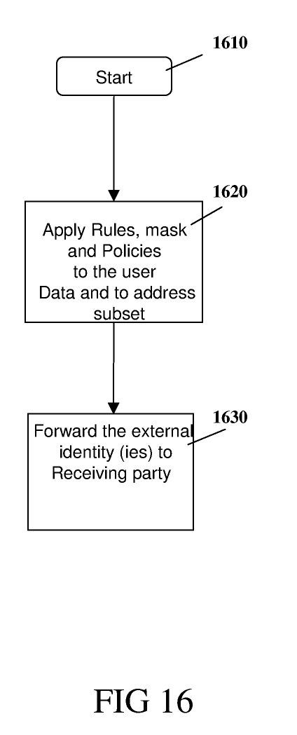

Reference is now made to FIG. 16. FIG. 16 illustrates a flow diagram for a method in accordance with the above.

The process starts at step 1610 and proceeds to step 1620, in which a set of address book field and value information (one or more external identities) are created by applying rules, mask and PEL policies.

The process then proceeds to step 1630 in which the one or more external identities are forwarded to a receiving party.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A computing device comprising:
a storage containing a contact data with a field that is associated with a link for filtering a subset of the contact data; and
a processor configured to execute an address book server for establishing, according to a rule, an identity that is based on the link, the identity consisting of the subset of the contact data.

2. The device of claim 1 wherein the rule is applied upon receiving a request for the contact data.

3. The device of claim 2 wherein the rule is created or modified based on user input upon receipt of the request.

4. The device of claim 1 wherein the rule is statically predefined by an owner of the contact data.

5. The device of claim 1 wherein additional information is included in or excluded from the identity according to a permission or level of access.

6. A method comprising:
associating a link with a field of a contact data to filter a subset of the contact data; and
using a rule to establish an identity based on the link, the identity consisting of the subset of the contact data.

7. The method of claim 6 wherein the rule is applied upon receiving a request for the contact data.

8. The method of claim 7 wherein the rule is created or modified based on user input upon receipt of the request.

9. The method of claim 6 wherein the rule is statically predefined by an owner of the contact data.

10. The method of claim 6 wherein additional information is included in or excluded from the identity according to a permission or level of access.

11. A tangible computer-readable medium containing instructions which, when executed by a processor, cause a computing device to perform the method of claim 6.
